(19) United States
(12) Patent Application Publication
(10) Pub. No.: US 2010/0222974 A1
(43) Pub. Date: Sep. 2, 2010

(54) CONTROL APPARATUS AND CONTROL METHOD FOR AUTOMATIC TRANSMISSION

(75) Inventors: Kazuaki Nakamura, Aichi-ken (JP); Kazuyuki Watanabe, Aichi-ken (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Toyota Jidosha Kabushiki Kaisha, Toyota-shi (JP)

(21) Appl. No.: 11/997,381

(22) PCT Filed: Aug. 24, 2006
(86) PCT No.: PCT/JP2006/317161

§ 371 Date: Jan. 30, 2008

(30) Foreign Application Priority Data
Sep. 7, 2005 (JP) 2005-259443

(51) Int. Cl. G06F 19/00

(52) U.S. Cl. 701/62

(57) ABSTRACT

An ECU executes a program including the step (S130) of inhibiting, in a traveling state where a one-way clutch F may engage as in driven state in first gear (YES in S100, YES in S110), normal gear-shifting control under which a gear to be implemented is determined based on the output shaft revolution number NO, in the case where the degree of change ΔNO by which the output shaft revolution number NO changes in a predetermined time period is larger than a threshold value Δ NO (1) (YES in S120) and thus it is regarded that popping could occur due to free turning of drive wheels, and the step (S140) of forcing the gear to be shifted to a gear except for first gear implemented by engagement of the one-way clutch F.

### TECHNICAL FIELD

The present invention relates to a control apparatus and a control method for an automatic transmission. In particular, the invention relates to a control apparatus and a control method for an automatic transmission implementing a gear by engagement of a restraining member (one-way clutch) that allows rotation of an outer race and an inner race with respect to each other in one direction and restrains rotation thereof in the opposite direction.

### BACKGROUND ART

For an automatic transmission, a one-way clutch has conventionally been used. Japanese Patent Laying-Open No. 2-129454 discloses a lubricating apparatus for a one-way clutch that can force the one-way clutch to be lubricated. The lubricating apparatus for the one-way clutch lubricates the one-way clutch of an automatic transmission including a casing support wall extending inwardly from the inner surface of a casing, the one-way clutch disposed adjacent to the casing support wall, and a cylindrical member that is fitted commonly with the inner surface of an inner race of the one-way clutch and the inner surface of the casing support wall and that rotatably supports, on its inside, a rotating member. Splines are formed in the outer surface of the cylindrical member to form a first spline coupling portion with the inner surface of the casing support wall and form a second spline coupling portion with the inner surface of the inner race. In the casing support wall, a lubricating oil supply hole opening to the first spline coupling portion is formed. In the inner race, an oil hole extending through the inner race in the radial direction and opening to the first spline coupling portion is formed. On the outside of the opening of the first spline coupling portion, on the outside of the opening of the second spline coupling portion and between the casing support wall and the side surface of the inner race, seal portions are provided respectively to form a lubricating oil passage that extends from the lubricating oil supply hole through the first and second spline coupling portions and the oil hole to reach a slide portion of the one-way clutch.

In the lubricating apparatus for the one-way clutch as disclosed in the aforementioned publication, the lubricating oil from the lubricating oil supply hole is supplied to the slide portion of the one-way clutch through a first spline between the inner surface of the casing support wall and the outer surface of the cylindrical member, a second spline between the inner surface of the inner race of the one-way clutch and the outer surface of the cylindrical member and the oil hole extending radially through the inner race. In other words, the lubricating oil supply hole, the first spline, the second spline, and the oil hole form the lubricating oil passage for lubricating the one-way clutch. Further, here, the lubricating oil passage is sealed by the seal portions and thus the lubricating oil does not leak anywhere from the lubricating oil passage. Thus, the lubricating oil supplied from the lubricating oil supply hole is forced to be supplied to the slide portion of the one-way clutch without depending on, for example, centrifugal force. Accordingly, the one-way clutch can surely be lubricated all the time with a sufficient amount of lubricating oil, and the durability and the reliability of the one-way clutch can remarkably be improved.

Some one-way clutches used for the automatic transmission are configured each to restrain (in engaged state) rotation of the outer race and the inner race with respect to each other in the case of drive in such a gear as first gear implemented by using the one-way clutch (in the case of travel by means of drive power of the vehicle) and, otherwise (for example, in the case of such travel as coasting without depending on drive power of the vehicle) allow (in disengaged state) the rotation. It is thus configured for the purpose of keeping stability of such gear shifting involving any gear implemented by the one-way clutch as gear shifting from first gear to second gear or for the purpose of suppressing deterioration in drivability, by an engine brake in any gear implemented by the one-way clutch. In the case, for example, where the vehicle is traveling on an undulating road surface, the vehicle oscillates up and down and accordingly it repeatedly occurs that wheels separate from and contact the road surface or that the driver is shaken and the accelerator pedal position changes. In such a case, the one-way clutch repeatedly allows and restrains rotation of the outer race and the inner race with respect to each other. Consequently, a considerably large shock load is applied to the one-way clutch to cause popping (namely such components of the one-way clutch as sprags, locking elements, rollers violently oscillate and randomly move) and thus the one-way clutch could be damaged. However, the lubricating apparatus for the one-way clutch disclosed in Japanese Patent Laying-Open No. 2-129454 does not suppress damage to the one-way clutch in such a case as the aforementioned one.

### DISCLOSURE OF THE INVENTION

An object of the present invention is to provide a control apparatus and a control method for an automatic transmission that can suppress damage to a one-way clutch.

According to an aspect of the present invention, a control apparatus for an automatic transmission controls the automatic transmission implementing a gear by engagement of any of a plurality of frictional engagement elements. At least any one of gears to be implemented is implemented by engagement of a restraining member allowing rotation of an outer race and an inner race with respect to each other in one direction and restraining rotation thereof in the opposite direction, in addition to the engagement of the frictional engagement elements. The control apparatus includes: a sensing unit sensing the number of revolutions of an output shaft of the automatic transmission; a first control unit controlling, in the case where a degree of change by which the number of revolutions of the output shaft changes in a predetermined time period is larger than a predetermined degree of change, the frictional engagement elements so that a gear is implemented that is different from the gear implemented by the engagement of the restraining member; a second control unit controlling the frictional engagement elements so that a gear is implemented based on the number of revolutions of the output shaft; and an inhibiting unit inhibiting the control by the second control unit, in the case where the degree of change by which the number of revolutions of the output shaft changes in the predetermined time period is larger than the predetermined degree of change.

According to the present invention, a gear is implemented by engagement of any of a plurality of frictional engagement elements (such as clutch and brake). At least any one of gears to be implemented is implemented by engagement of the restraining member (such as one-way clutch) in addition of the engagement of the frictional engagement elements. In the case where a degree of change by which the number of revolutions of the output shaft of such an automatic transmission as described above in a predetermined time period is large, this can be regarded as the case where it is repeated that wheels separate from and contact a road surface or that the driver is shaken to cause the accelerator pedal position to change and accordingly the load exerted on the automatic transmission increases/decreases in short cycles. In this case, it could repeatedly occur that rotation of the outer race and the inner race with respect to each other is permitted and restrained. If the permission and restraint of rotation of the outer race and the inner race with respect to each other is repeated, popping could occur to damage the one-way clutch. Therefore, in the case where the degree of change by which the number of revolutions of the output shaft in a predetermined time period is large, the frictional engagement elements are controlled so that a gear is implemented that is different from the gear implemented by the engagement of the restraining member. Thus, engagement of the restraining member can be suppressed. Therefore, occurrence of popping can be suppressed. Further, here, it is inhibited that the frictional engagement elements are controlled so that a gear is implemented based on the number of revolutions of the output shaft. Accordingly, it can be suppressed that the gear implemented by the engagement of the restraining member is implemented again. Accordingly, occurrence of popping of the one-way clutch can be suppressed. Thus, the control apparatus for the automatic transmission that can suppress damage to the one-way clutch can be provided.

Preferably, the control apparatus further includes: a stopping unit stopping the control by the first control unit, in the case where the degree of change by which the number of revolutions of the output shaft changes in the predetermined time period is at most a degree of change smaller than the predetermined degree of change under the condition that the control by the first control unit is executed while the control by the second control unit is inhibited; and a canceling unit canceling the inhibition of the control by the second control unit, in the case where the degree of change by which the number of revolutions of the output shaft changes in the predetermined time period is at most the degree of change smaller than the predetermined degree of change under the condition that the control by the first control unit is executed while the control by the second control unit is inhibited.

According to the present invention, when the degree of change by which the number of revolutions of the output shaft changes in a predetermined time period decreases under the condition that the control by the first control unit is executed while the control by the second control unit is inhibited, the control by the first control unit may be stopped and the inhibition of the control by the second control unit may be cancelled. Here, during travel in the gear implemented by engagement of the restraining member, the degree of change by which the number of revolutions changes in the case where wheels separate from the road surface tends to be increased by the fact that the restraining member allows a difference in number of revolutions between the outer race and the inner race. In contrast, in the case where a difference in number of revolutions between the outer race and the inner race is suppressed by the frictional engagement elements, the aforementioned degree of change by which the number of revolutions changes tends to decrease. Further, the degree of change by which the number of revolutions changes could decrease according to a gear (gear ratio). Thus, in the case where the degree of change by which the number of revolutions of the output shaft changes in a predetermined time period is equal to or smaller than a degree of change smaller than a predetermined degree of change because of execution of the control by the first control unit or inhibition of the control by the second control unit, the control by the first control unit may be stopped and the inhibition of the control by the second control unit may be cancelled. Accordingly, the control by the first control unit may be stopped and the inhibition of the control by the second control unit may be cancelled, using a threshold value according to the state of the automatic transmission, at a timing precisely adjusted to a timing at which it is considered that popping does not occur. Thus, it can be suppressed that the control by the first control unit is stopped and the inhibition of the control by the second control unit is cancelled in a traveling state in which popping could occur. Accordingly, occurrence of popping can be suppressed to suppress damage to the one-way clutch.

According to another aspect of the present invention, a control apparatus for an automatic transmission controls the automatic transmission implementing a gear by engagement of any of a plurality of frictional engagement elements. At least any one of gears to be implemented is implemented by engagement of a restraining member allowing rotation of an outer race and an inner race with respect to each other in one direction and restraining rotation thereof in the opposite direction, in addition to the engagement of the frictional engagement elements. A difference in number of revolutions between the outer race and the inner race is suppressed by engagement of at least any one of a plurality of the frictional engagement elements. The control apparatus includes: a sensing unit sensing the number of revolutions of an output shaft of the automatic transmission; a first control unit controlling, in the case where a degree of change by which the number of revolutions of the output shaft changes in a predetermined time period is larger than a predetermined degree of change, the frictional engagement elements so that the difference in number of revolutions between the outer race and the inner race is suppressed; a second control unit controlling the frictional engagement elements so that a gear is implemented based on the number of revolutions of the output shaft; and an inhibiting unit inhibiting the control by the second control unit, in the case where the degree of change by which the number of revolutions of the output shaft changes in the predetermined time period is larger than the predetermined degree of change.

According to the present invention, a gear is implemented by engagement of any of a plurality of frictional engagement elements (such as clutch and brake). At least any one of gears to be implemented is implemented by engagement of the restraining member (such as one-way clutch) in addition of the engagement of the frictional engagement elements. By engagement of at least any one of these frictional engagement elements, a difference in number of revolutions between the outer race and the inner race is suppressed. In the case where a degree of change by which the number of revolutions of the output shaft of such an automatic transmission as described above in a predetermined time period is large, this can be regarded as the case where it is repeated that wheels separate from and contact a road surface or that the driver is shaken to cause the accelerator pedal position to change and accordingly the load exerted on the automatic transmission increases/decreases in short cycles. In this case, it could repeatedly occur that rotation of the outer race and the inner race with respect to each other is permitted and restrained. If the permission and restraint of rotation of the outer race and the inner race with respect to each other is repeated, popping could occur to damage the one-way clutch. Therefore, in the case where the degree of change by which the number of revolutions of the output shaft in a predetermined time period is large, the frictional engagement elements are controlled so that a difference in number of revolutions between the outer race and the inner race is suppressed. Further, here, it is inhibited that the frictional engagement elements are controlled so that a gear is implemented based on the number of revolutions of the output shaft. Accordingly, a priority can be given to engagement of the frictional engagement elements for suppressing a difference in number of revolutions between the outer race and the inner race, over shift to a gear in which the frictional engagement elements suppressing a difference in number of revolutions between the outer race and the inner race are disengaged. Thus, a difference in number of revolutions between the outer race and the inner race can be suppressed to suppress occurrence of popping. Thus, the control apparatus for the automatic transmission that can suppress damage to one-way clutch can be provided.

Preferably, the control apparatus further includes a third control unit controlling, in the case where the control by the second control unit is inhibited, the frictional engagement elements so that a gear is implemented based on an average of the number of revolutions of the output shaft in a predetermined time period.

According to the present invention, in the case where it is inhibited that a gear is implemented based on the number of revolutions of the output shaft, the gear is implemented based on an average of the number of revolutions of the output shaft in a predetermined time period, instead of the number of revolutions of the output shaft. Accordingly, while it is suppressed that gear shifting, which is unnecessary, of the automatic transmission is done due to a sudden change in number of revolutions of the output shaft, gear shifting can be done in the case where the vehicle speed actually changes to cause the number of revolutions of the output shaft to change and thus the gear shifting is necessary. Thus, travel in a gear appropriate for a traveling state of the vehicle can be accomplished.

Still preferably, the control apparatus further includes: a stopping unit stopping the control by the first control unit, in the case where the degree of change by which the number of revolutions of the output shaft changes in the predetermined time period is at most a degree of change smaller than the predetermined degree of change under the condition that the control by the first control unit is executed while the control by the second control unit is inhibited; and a canceling unit canceling the inhibition of the control by the second control unit, in the case where the degree of change by which the number of revolutions of the output shaft changes in the predetermined time period is at most the degree of change smaller than, the predetermined degree of change under the condition that the control by the first control unit is executed while the control by the second control unit is inhibited.

According to the present invention, when the degree of change by which the number of revolutions of the output shaft changes in a predetermined time period decreases under the condition that the control by the first control unit is executed while the control by the second control unit is inhibited, the control by the first control unit may be stopped and the inhibition of the control by the second control unit may be cancelled. Here, during travel in the gear implemented by engagement of the restraining member, the degree of change by which the number of revolutions changes in the case where wheels separate from the road surface tends to be increased by the fact that the restraining member allows a difference in number of revolutions between the outer race and the inner race. In contrast, in the case where a difference in number of revolutions between the outer race and the inner race is suppressed by the frictional engagement elements, the aforementioned degree of change by which the number of revolutions changes tends to decrease. Further, the degree of change by which the number of revolutions change could decrease according to a gear (gear ratio). Thus, in the case where the degree of change by which the number of revolutions of the output shaft changes in a predetermined time period is equal to or smaller than a degree of change smaller than a predetermined degree of change because of execution of the control by the first control unit or inhibition of the control by the second control unit, the control by the first control unit may be stopped and the inhibition of the control by the second control unit may be cancelled. Accordingly, the control by the first control unit may be stopped and the inhibition of the control by the second control unit may be cancelled, using a threshold value according to the state of the automatic transmission, at a timing precisely adjusted to a timing at which it is considered that popping does not occur. Thus, it can be suppressed that the control by the first control unit is stopped and the inhibition of the control by the second control unit is cancelled in a traveling state in which popping could occur. Accordingly, occurrence of popping can be suppressed to suppress damage to the one-way clutch.

According to still another aspect of the present invention, a control method for an automatic transmission is a control method for an automatic transmission implementing a gear by engagement of any of a plurality of frictional engagement elements. At least any one of gears to be implemented is implemented by engagement of a restraining member allowing rotation of an outer race and an inner race with respect to each other in one direction and restraining rotation thereof in the opposite direction, in addition to the engagement of the frictional engagement elements. The control method includes the steps of: determining whether or not a degree of change by which the number of revolutions of an output shaft of the automatic transmission changes in a predetermined time period is larger than a predetermined degree of change; and inhibiting gear-shifting control under which a gear to be implemented is determined based on the number of revolutions of the output shaft and controlling the frictional engagement elements so that a gear is implemented that is different from the gear implemented by the engagement of the restraining member, in the case where it is determined that the degree of change by which the number of revolutions of the output shaft changes in the predetermined time period is larger than the predetermined degree of change.

According to the present invention, a gear is implemented by engagement of any of a plurality of frictional engagement elements (such as clutch and brake). At least any one of gears to be implemented is implemented by engagement of the restraining member (such as one-way clutch) in addition of the engagement of the frictional engagement elements. In the case where a degree of change by which the number of revolutions of the output shaft of such an automatic transmission as described above in a predetermined time period is large, this can be regarded as the case where it is repeated that wheels separate from and contact a road surface or that the driver is shaken to cause the accelerator pedal position to change and accordingly the load exerted on the automatic transmission increases/decreases in short cycles. In this case, it could repeatedly occur that rotation of the outer race and the inner race with respect to each other is permitted and restrained. If the permission and restraint of rotation of the outer race and the inner race with respect to each other is repeated, popping could occur to damage the one-way clutch. Therefore, in the case where it is determined that the degree of change by which the number of revolutions of the output shaft in a predetermined time period is large, the frictional engagement elements are controlled so that a gear is implemented that is different from the gear implemented by the engagement of the restraining member. Thus, engagement of the restraining member can be suppressed. Therefore, occurrence of popping can be suppressed. Further, here, gear-shifting control under which a gear to be implemented is determined based on the number of revolutions of the output shaft is inhibited. Accordingly, it can be suppressed that the gear implemented by the engagement of the restraining member is implemented again. Accordingly, occurrence of popping of the one-way clutch can be suppressed. Thus, the control method for the automatic transmission that can suppress damage to the one-way clutch can be provided.

Preferably, the control method further includes the steps of: determining, when the gear-shifting control under which a gear to be implemented is determined based on the number of revolutions of the output shaft is inhibited and the frictional engagement elements are controlled so that a gear is implemented that is different from the gear implemented by the engagement of the restraining member, whether or not the degree of change by which the number of revolutions of the output shaft changes in the predetermined time period is at most a degree of change smaller than the predetermined degree of change; and canceling the inhibition of the gear-shifting control under which a gear to be implemented is determined based on the number of revolutions of the output shaft, in the case where it is determined that the degree of change by which the number of revolutions of the output shaft changes in the predetermined time period is at most a degree of change smaller than the predetermined degree of change, when the gear-shifting control under which a gear to be implemented is determined based on the number of revolutions of the output shaft is inhibited and the frictional engagement elements are controlled so that a gear is implemented that is different from the gear implemented by the engagement of the restraining member.

According to the present invention, when the degree of change by which the number of revolutions of the output shaft changes in a predetermined time period decreases in the case where the gear-shifting control under which a gear to be implemented is determined based on the number of revolutions of the output shaft is inhibited and the frictional engagement elements are controlled so that a gear is implemented that is different from the gear implemented by the engagement of the restraining member, the inhibition of the gear-shifting control under which a gear to be implemented is determined based on the number of revolutions of the output shaft is cancelled. Here, during travel in the gear implemented by engagement of the restraining member, the degree of change by which the number of revolutions changes in the case where wheels separate from the road surface tends to be increased by the fact that the restraining member allows a difference in number of revolutions between the outer race and the inner race. In contrast, in the case where a difference in number of revolutions between the outer race and the inner race is suppressed by the frictional engagement elements, the aforementioned degree of change by which the number of revolutions changes tends to decrease. Further, the degree of change by which the number of revolutions changes could decrease according to a gear (gear ratio). Thus, in the case where the degree of change by which the number of revolutions of the output shaft changes in a predetermined time period is equal to or smaller than a degree of change smaller than a predetermined degree of change because of the fact that the gear-shifting control under which a gear to be implemented is determined based on the number of revolutions of the output shaft is inhibited and a gear is implemented that is different from the gear implemented by the engagement of the restraining member, the inhibition of the gear-shifting control under which a gear to be implemented is determined based on the number of revolutions of the output shaft is cancelled. Accordingly, the inhibition of the gear-shifting control under which a gear to be implemented is determined based on the number of revolutions of the output shaft may be cancelled, using a threshold value according to the state of the automatic transmission, at a timing precisely adjusted to a timing at which it is considered that popping does not occur. Thus, it can be suppressed that the inhibition of the gear-shifting control under which a gear to be implemented is determined based on the number of revolutions of the output shaft is cancelled in a traveling state in which popping could occur. Accordingly, occurrence of popping can be suppressed to suppress damage to the one-way clutch.

According to a further aspect of the present invention, a control method for an automatic transmission is a control method for an automatic transmission implementing a gear by engagement of any of a plurality of frictional engagement elements. At least any one of gears to be implemented is implemented by engagement of a restraining member allowing rotation of an outer race and an inner race with respect to each other in one direction and restraining rotation thereof in the opposite direction, in addition to the engagement of the frictional engagement elements. A difference in number of revolutions between the outer race and the inner race is suppressed by engagement of at least any one of a plurality of the frictional engagement elements. The control method includes the steps of: determining whether or not a degree of change by which the number of revolutions of an output shaft of the automatic transmission changes in a predetermined time period is larger than a predetermined degree of change; and inhibiting gear-shifting control under which a gear to be implemented is determined based on the number of revolutions of the output shaft and controlling the frictional engagement elements so that the difference in number of revolutions between the outer race and the inner race is suppressed, in the case where it is determined that the degree of change by which the number of revolutions of the output shaft changes in the predetermined time period is larger than the predetermined degree of change.

According to the present invention, a gear is implemented by engagement of any of a plurality of frictional engagement elements (such as clutch and brake). At least any one of gears to be implemented is implemented by engagement of the restraining member (such as one-way clutch) in addition of the engagement of the frictional engagement elements. By engagement of at least any one of these frictional engagement elements, a difference in number of revolutions between the outer race and the inner race is suppressed. In the case where a degree of change by which the number of revolutions of the output shaft of such an automatic transmission as described above in a predetermined time period is large, this can be regarded as the case where it is repeated that wheels separate from and contact a road surface or that the driver is shaken to cause the accelerator pedal position to change and accordingly the load exerted on the automatic transmission increases/decreases in short cycles. In this case, it could repeatedly occur that rotation of the outer race and the inner race with respect to each other is permitted and restrained. If the permission and restraint of rotation of the outer race and the inner race with respect to each other is repeated, popping could occur to damage the one-way clutch. Therefore, in the case where it is determined that the degree of change by which the number of revolutions of the output shaft in a predetermined time period is large, the frictional engagement elements are controlled so that a difference in number of revolutions between the outer race and the inner race is suppressed. Further, here, the gear-shifting control under which a gear to be implemented is determined based on the number of revolutions of the output shaft is inhibited. Accordingly, a priority can be given to engagement of the frictional engagement elements for suppressing a difference in number of revolutions between the outer race and the inner race, over shift to a gear in which the frictional engagement elements suppressing a difference in number of revolutions between the outer race and the inner race are disengaged. Thus, a difference in number of revolutions between the outer race and the inner race can be suppressed to suppress occurrence of popping. Thus, the control method for the automatic transmission that can suppress damage to one-way clutch can be provided.

Preferably, the control method further includes the step of executing gear-shifting control under which a gear to be implemented is determined based on an average of the number of revolutions of the output shaft in a predetermined time period, in the case where the gear-shifting control under which a gear to be implemented is determined based on the number of revolutions of the output shaft is inhibited.

According to the present invention, in the case where it is inhibited that a gear is implemented based on the number of revolutions of the output shaft, the gear is implemented based on an average of the number of revolutions of the output shaft in a predetermined time period, instead of the number of revolutions of the output shaft. Accordingly, while it is suppressed that gear shifting, which is unnecessary, of the automatic transmission is done due to a sudden change in number of revolutions of the output shaft, gear shifting can be done in the case where the vehicle speed actually changes to cause the number of revolutions of the output shaft to change and thus the gear shifting is necessary. Thus, travel in a gear appropriate for a traveling state of the vehicle can be accomplished.

Still preferably, the control method further includes the steps of: determining, when the gear-shifting control under which a gear to be implement is determined based on the number of revolutions of the output shaft is inhibited and the frictional engagement elements are controlled so that the difference in number of revolutions between the outer race and the inner race is suppressed, whether or not the degree of change by which the number of revolutions of the output shaft changes in the predetermined time period is at most a degree of change smaller than the predetermined degree of change; and stopping the control of the frictional engagement elements for suppressing the difference in number of revolutions between the outer race and the inner race and canceling the inhibition of the gear-shifting control under which a gear to be implemented is determined based on the number of revolutions of the output shaft, in the case where it is determined that the degree of change by which the number of revolutions of the output shaft changes in the predetermined time period is at most a degree of change smaller than the predetermined degree of change, when the gear-shifting control under which a gear to be implemented is determined based on the number of revolutions of the output shaft is inhibited and the frictional engagement elements are controlled so that the difference in number of revolutions between the outer race and the inner race is suppressed.

According to the present invention, when the degree of change by which the number of revolutions of the output shaft changes in a predetermined time period decreases in the case where the gear-shifting control under which a gear to be implemented is determined based on the number of revolutions of the output shaft is inhibited and the frictional engagement elements are controlled so that the difference in number of revolutions between the outer race and the inner race is suppressed, the control of the frictional engagement elements for suppressing the difference in number of revolutions between the outer race and the inner race is stopped, and the inhibition of the gear-shifting control under which a gear to be implemented is determined based on the number of revolutions of the output shaft is cancelled. Here, during travel in the gear implemented by engagement of the restraining member, the degree of change by which the number of revolutions changes in the case where wheels separate from the road surface tends to be increased by the fact that the restraining member allows a difference in number of revolutions between the outer race and the inner race. In contrast, in the case where a difference in number of revolutions between the outer race and the inner race is suppressed by the frictional engagement elements, the aforementioned degree of change by which the number of revolutions changes tends to decrease. Further, the degree of change by which the number of revolutions change could decrease according to a gear (gear ratio). Thus, in the case where the degree of change by which the number of revolutions of the output shaft changes in a predetermined time period is equal to or smaller than a degree of change smaller than a predetermined degree of change because of the fact that the gear-shifting control under which a gear to be implemented is determined based on the number of revolutions of the output shaft is inhibited and the frictional engagement elements are controlled so that the difference in number of revolutions between the outer race and the inner race is suppressed, the control of the frictional engagement elements for suppressing the difference in number of revolutions between the outer race and the inner race is stopped and the inhibition of the gear-shifting control under which a gear to be implemented is determined based on the number of revolutions of the output shaft is cancelled. Accordingly, the control of the frictional engagement elements for suppressing the difference in number of revolutions between the outer race and the inner race may be stopped and the inhibition of the gear-shifting control under which a gear to be implemented is determined based on the number of revolutions of the output shaft may be cancelled, using a threshold value according to the state of the automatic transmission, at a timing precisely adjusted to a timing at which it is considered that popping does not occur. Thus, it can be suppressed that the control of the frictional engagement elements for suppressing the difference in number of revolutions between the outer race and the inner race is stopped and the inhibition of the gear-shifting control under which a gear to be implemented is determined based on the number of revolutions of the output shaft is cancelled in a traveling state in which popping could occur. Accordingly, occurrence of popping can be suppressed to suppress damage to the one-way clutch.

### BRIEF DESCRIPTION OF THE DRAWINGS

FIG. 1 is a schematic view of a powertrain under control of an ECU (Electronic Control Unit) qualified as a control apparatus according to a first embodiment of the present invention.

FIG. 2 is a skeletal view of a geartrain in a transmission.

FIG. 3 represents an operation table of a transmission.

FIG. 4 shows a portion of an oil hydraulic circuit in the transmission.

FIG. 5 is a flowchart showing a control structure of a program executed by the ECU qualified as the control apparatus according to the first embodiment of the present invention.

FIG. 6 is a flowchart showing a control structure of a program executed by an ECU qualified as a control apparatus according to a second embodiment of the present invention.

### BEST MODES FOR CARRYING OUT THE INVENTION

Embodiments of the present invention will be described hereinafter with reference to the drawings. In the following description, the same elements have the same reference characters allotted. Their designation and function are also identical. Therefore, detailed description thereof will not be repeated.

### First Embodiment

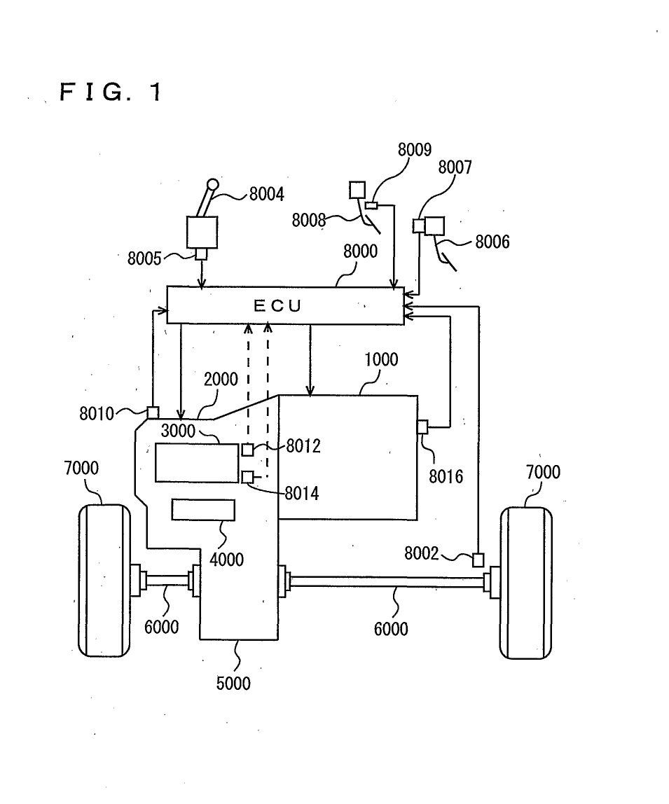

A vehicle incorporating a control apparatus according to a first embodiment of the present invention will be described with reference to FIG. 1. The vehicle is an FF (Front engine Front drive) vehicle. The vehicle incorporating the control apparatus for an automatic transmission according to the present embodiment is not limited to the FF vehicle.

The vehicle includes an engine 1000, a transmission 2000, a planetary gear unit 3000 constituting a portion of transmission 2000, an oil hydraulic circuit 4000 constituting a portion of transmission 2000, a differential gear 5000, a drive shaft 6000, a front wheel 7000, and an ECU (Electronic Control Unit) 8000.

Engine 1000 is an internal combustion engine that burns a mixture consisting of fuel injected from an injector (not shown) and air, inside a combustion chamber of a cylinder. A piston in the cylinder is pushed down by the combustion, whereby a crankshaft is rotated. An external combustion engine may be employed instead of an internal combustion engine. Further, engine 1000 may be substituted with a rotating electric machine.

Transmission 2000 converts the revolution speed of the crankshaft to a desired revolution speed for speed change by implementing a desired gear. The output gear of transmission 2000 meshes with differential gear 5000.

A driveshaft 6000 is coupled to differential gear 5000 by spline-fitting for example. Motive power is transmitted to the left and right front wheels 7000 via driveshaft 6000.

A vehicle speed sensor 8002, a position switch 8005 of a shift lever 8004, an accelerator pedal position sensor 8007 of an accelerator pedal 8006, a stop lamp switch 8009 provided at a brake pedal 8008, an oil temperature sensor 8010, an input shaft speed sensor 8012, an output shaft speed sensor 8014, and a coolant temperature sensor 8016 are connected to ECU 8000 via a harness and the like.

Vehicle speed sensor 8002 senses the vehicle speed from the revolution number of drive shaft 6000, and transmits a signal representing the sensed result to ECU 8000. The position of shift lever 8004 is sensed by position switch 8005, and a signal representing the sensed result is transmitted to ECU 8000. A gear of transmission 2000 is automatically implemented corresponding to the position of shift lever 8004. Additionally, the driver may operate to select a manual shift mode in which the driver can select a gear arbitrarily.

Accelerator pedal position sensor 8007 detects the position of accelerator pedal 8006, and transmits a signal representing the detected result to ECU 8000. Stop lamp switch 8009 senses the ON/OFF state of brake pedal 8008, and transmits a signal representing the sensed result to ECU 8000. A stroke sensor sensing the stroke level of brake pedal 8008 may be provided instead of or in addition to stops lamp switch 8009.

Oil temperature sensor 8010 senses the temperature of the ATF (Automatic Transmission Fluid) of transmission 2000, and transmits a signal representing the sensed result to ECU 8000.

Input shaft speed sensor 8012 senses the input shaft revolution number NI of transmission 2000, and transmits a signal representing the sensed result to ECU 8000. Output shaft speed sensor 8014 senses the output shaft revolution number NO of transmission 2000, and transmits a signal representing the sensed result to ECU 8000. Coolant temperature sensor 8016 senses the temperature of the coolant of engine 1000, and transmits a signal representing the sensed result to ECU 8000.

ECU 8000 controls various devices such that the vehicle attains a desired traveling state based on signals transmitted from vehicle speed sensor 8002, position switch 8005, accelerator pedal position sensor 8007, stop lamp switch 8009, oil temperature sensor 8010, input shaft speed sensor 8012, output shaft speed sensor 8014, and the like, as well as map and program stored in a ROM (Read Only Memory).

In the present embodiment, ECU 8000 determines the gear to be implemented according to a gear shift map produced based on such parameters as the output shaft revolution number NO and the accelerator pedal position.

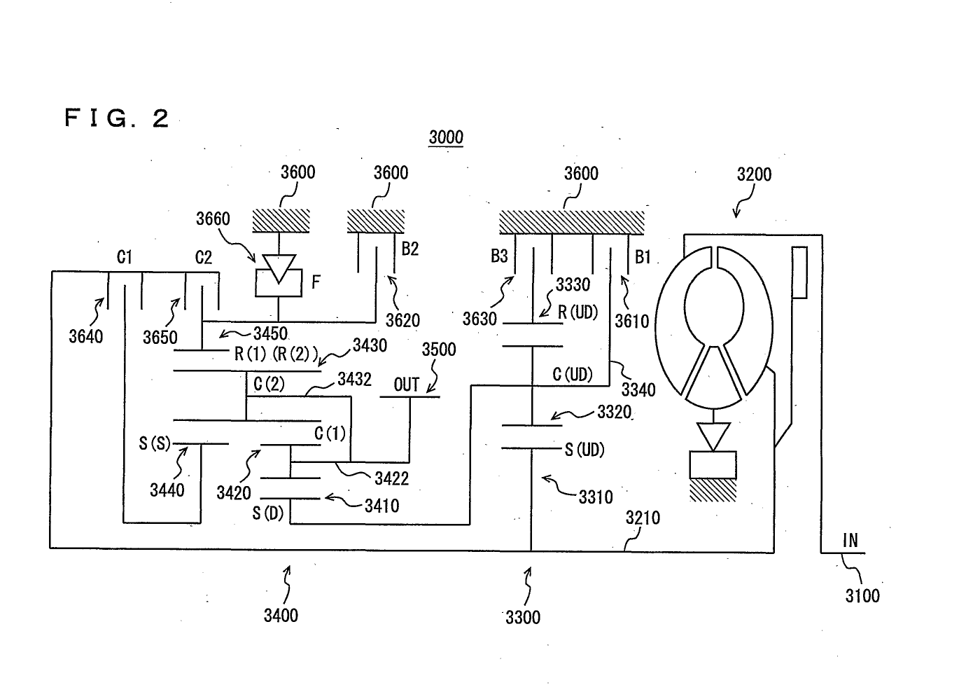

Planetary gear unit 3000 will be described with reference to FIG. 2. Planetary gear unit 3000 is connected to a torque converter 3200 having an input shaft 3100 coupled to the crankshaft. Planetary gear unit 3000 includes a first set of the planetary gear mechanism 3300, a second set of the planetary gear mechanism 3400, an output gear 3500, B1, B2, and B3 brakes 3610, 3620 and 3630 fixed to a gear case 3600, C1 and C2 clutches 3640 and 3650, and a one-way clutch F 3660.

First set 3300 is a single pinion type planetary gear mechanism. First set 3300 includes a sun gear S (UD) 3310, a pinion gear 3320, a ring gear R (UD) 3330, and a carrier C (UD) 3340.

Sun gear S (UD) 3310 is coupled to an output shaft 3210 of torque converter 3200. Pinion gear 3320 is rotatably supported on carrier C (UD) 3340. Pinion gear 3320 engages with sun gear S (UD) 3310 and ring gear R (UD) 3300.

Ring gear R (UD) 3330 is fixed to gear case 3600 by B3 brake 3630. Carrier C (UD) 3340 is fixed to gear case 3600 by B1 brake 3610.

Second set 3400 is a Ravigneaux type planetary gear mechanism. Second set 3400 includes a sun gear S (D) 3410, a short pinion gear 3420, a carrier C (1) 3422, a long pinion gear 3430, a carrier C (2) 3432, a sun gear S (S) 3440, and a ring gear R (1) (R (2)) 3450.

Sun gear S (D) 3410 is coupled to carrier C (UD) 3340. Short pinion gear 3420 is rotatably supported on carrier C (1) 3422. Short pinion gear 3420 engages with sun gear S (D) 3410 and long pinion gear 3430. Carrier C (1) 3422 is coupled with output gear 3500.

Long pinion gear 3430 is rotatably supported on carrier C (2) 3432. Long pinion gear 3430 engages with short pinion gear 3420, sun gear S (S) 3440, and ring gear R (1) (R (2)) 3450. Carrier C (2) 3432 is coupled with output gear 3500.

Sun gear S (S) 3440 is coupled to output shaft 3210 of torque converter 3200 by C1 clutch 3640. Ring gear R (1) (R (2)) 3450 is fixed to gear case 3600 by B2 brake 3620, and coupled to output shaft 3210 of torque converter 3200 by C2 clutch 3650. Ring gear R (1) (R (2)) 3450 is coupled to one-way clutch F 3660, and is disabled in rotation during the drive in first gear.

One-way clutch F 3660 is provided in parallel with B2 brake 3620. Specifically, one-way clutch F 3660 has the outer race fixed to gear case 3600, and the inner race coupled to ring gear R (1) (R (2)) 3450 via the rotation shaft.

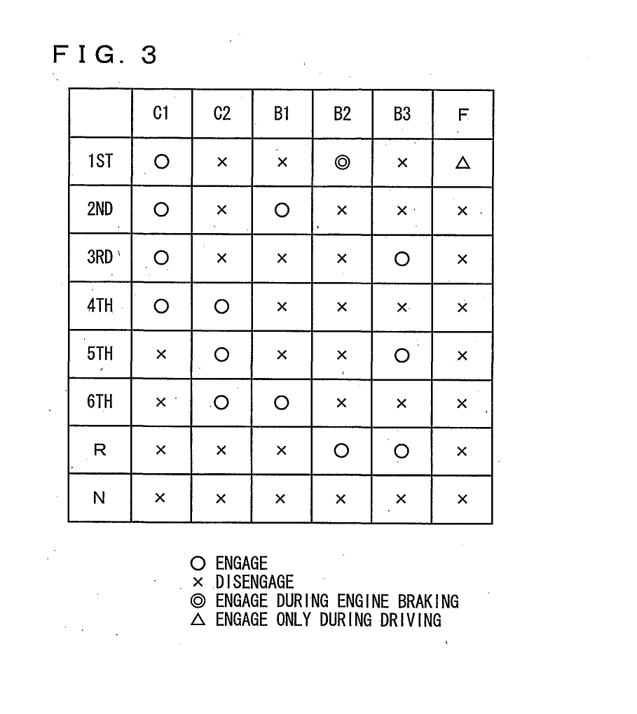

FIG. 3 is an operation table representing the relation between gears to be shifted and operation states of the clutches and brakes. By operating each brake and each clutch based on the combination shown in the operation table, the forward gears including first gear to sixth gear and the reverse gear are implemented.

Since one-way clutch F 3660 is provided in parallel with B2 brake 3620, it is not necessary to engage B2 brake 3620 in a driving state from the engine, side (acceleration) during implementation of first gear (1ST), as indicated in the operation table.

During the drive in first gear, one-way clutch F 3660 restrains the rotation of ring gear R (1) (R (2)) 3450. When engine brake is effected, one-way clutch F 3660 does not restrain the rotation of ring gear R (1) (R (2)) 3450.

Specifically, during the drive under normal gear-shifting control, first gear is implemented by engagement of C1 clutch 3640 and one-way clutch F 3660. During engine braking under the normal gear-shifting control, first gear is implemented by engagement of C1 clutch 3640 and B2 brake 3620.

It is noted that, although transmission 2000 employed here includes the one-way clutch which is used to implement first gear only, the automatic transmission may include a one-way clutch which is used to implement any gear(s) except for first gear. The present invention may thus be applied to the case where any, gear is implemented by means of this one-way clutch.

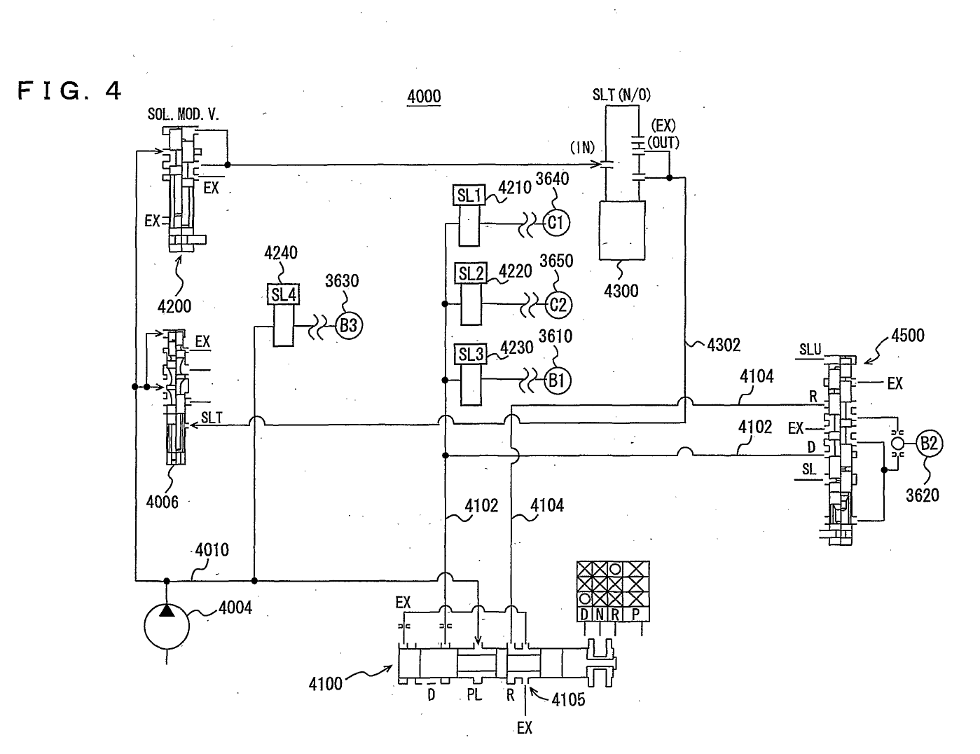

Oil hydraulic circuit 4000 will be described hereinafter with reference to FIG. 4. FIG. 4 represents only the portion of oil hydraulic circuit 4000 related to the present invention. Oil hydraulic circuit 4000 includes an oil pump 4004, a primary regulator valve 4006, a manual valve 4100, a solenoid modulator valve 4200, an SL1 linear solenoid (hereinafter, indicated as SL (1)) 4210, an SL2 linear solenoid (hereinafter, indicated as SL (2)) 4220, an SL3 linear solenoid (hereinafter, indicated as SL (3)) 4230, an SL4 linear solenoid (hereinafter, indicated as SL (4)) 4240, an SLT linear solenoid (hereinafter, indicated as SLT) 4300, and a B2 control valve 4500.

Oil pump 4004 is coupled with the crankshaft of engine 1000. By rotation of the crankshaft, oil pump 4004 is driven to generate oil pressure. The oil pressure generated at oil pump 4004 is adjusted by primary regulator valve 4006, whereby line pressure is generated.

Primary regulator valve 4006 operates with the throttle pressure adjusted by SLT 4300 as the pilot pressure. The line pressure is supplied to manual valve 4100 via a line pressure oil channel 4010. The line pressure is adjusted by SL (4) 4240 to be supplied to B3 brake 3630.

Manual valve 4100 includes a drain port 4105. The oil pressure of a D range pressure oil channel 4102 and an R range pressure oil channel 4104 is discharged from drain port 4105. When the spool of manual valve 4100 is at the D position, line pressure oil channel 4010 communicates with D range pressure oil channel 4102, whereby oil pressure is supplied to D range pressure oil channel 4102. At this stage, R range pressure oil channel 4104 communicate with drain port 4105, whereby the R range pressure of R range pressure oil channel 4104 is discharged from drain port 4105.

When the spool of manual valve 4100 is at the R position, line pressure oil channel 4010 communicates with R range pressure oil channel 4104, whereby oil pressure is supplied to R range pressure oil channel 4104. At this stage, D range pressure oil channel 4102 communicates with drain port 4105, whereby the D range pressure of D range pressure oil channel 4102 is discharged from drain port 4105.

When the spool of manual valve 4100 is at the N position, D range pressure oil channel 4102 and R range pressure oil channel 4104 both communicate with drain port 4105, whereby the D range pressure of D range pressure oil channel 4102 and the R range pressure of R range pressure oil channel 4104 are discharged from drain port 4105.

The oil pressure supplied to D range pressure oil channel 4102 is eventually supplied to B1 brake 3610, B2 brake 3620, C1 clutch 3640 and C2 clutch 3650.

The oil pressure supplied to R range pressure oil channel 4104 is eventually supplied to B2 brake 3620.

Solenoid modulator valve 4200 adjusts the line pressure at a constant level. The oil pressure adjusted by solenoid modulator valve 4200 (solenoid modulator pressure) is supplied to SLT 4300.

SL (1) 4210 adjusts the oil pressure supplied to C1 clutch 3640. SL (2) 4220 adjusts the oil pressure supplied to C2 clutch 3650. SL (3) 4230 adjusts the oil pressure supplied to B1 brake 3610.

SLT 4300 responds to a control signal from ECU 8000 based on the accelerator pedal position detected by accelerator pedal position sensor 8007 to adjust the solenoid modulator pressure and generate the throttle pressure. The throttle pressure is supplied to primary regulator valve 4006 via SLT oil channel 4302. The throttle pressure is used as the pilot pressure of primary regulator valve 4006.

SL (1) 4210, SL (2) 4220, SL (3) 4230 and SLT 4300 are controlled by a control signal transmitted from ECU 8000.

B2 control valve 4500 selectively supplies the oil pressure from one of D range pressure oil channel 4102 and R range pressure oil channel 4104 to B2 brake 3620. D range oil pressure 4102 and R range oil pressure 4104 are connected to B2 control valve 4500. B2 control valve 4500 is controlled by the oil pressure supplied from an SL solenoid valve (not shown) and an SLU solenoid valve (not shown) and the urge of the spring.

When the SL solenoid valve is OFF and SLU solenoid valve is ON, B2 control valve 4500 attains the left side state of FIG. 4. In this case, B2 brake 3620 is supplied with oil pressure having the D range pressure adjusted with the oil pressure supplied from the SLU solenoid valve as the pilot pressure.

When the SL solenoid valve is ON and the SLU solenoid valve is OFF, B2 control valve 4500 attains the right side state of FIG. 4. In this case, B2 brake 3620 is supplied with the R range pressure.

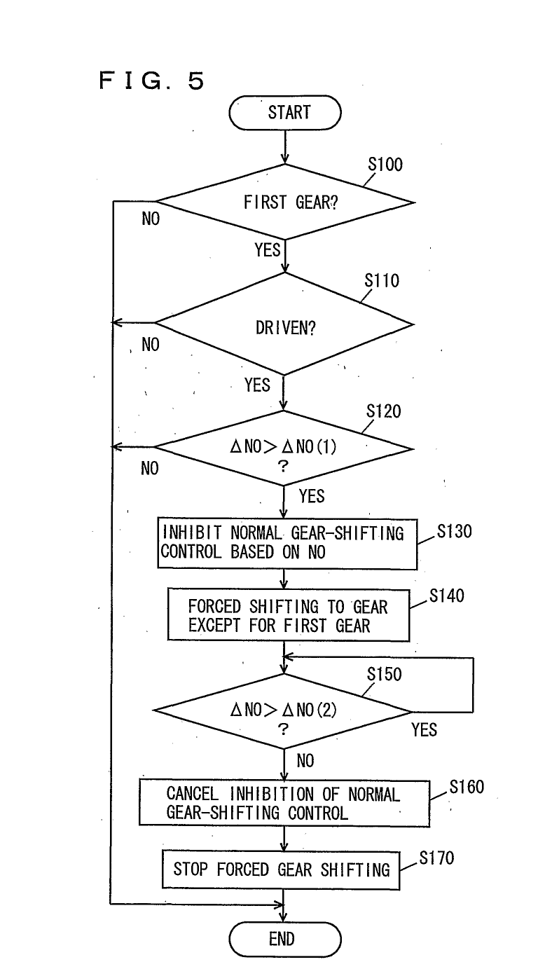

Referring to FIG. 5, a description will be given of a control structure of a program executed by ECU 8000 qualified as the control apparatus according to the present embodiment.

In step (step is hereinafter abbreviated as S) 100, ECU 8000 determines whether or not first gear is implemented. Whether or not first gear is implemented is determined based on the gear shift map stored in the ROM. When the first gear is implemented (YES in S100), the program proceeds to S110. Otherwise (NO in S100), the program is ended.

In S110, ECU 8000 determines whether or not in driven state (namely whether or not the vehicle travels by drive power from engine 1000). Whether or not in driven state is determined depending on, for example, whether or not the degree by which the accelerator pedal is depressed is greater than a predetermined degree. When in driven state (YES in S110), the program proceeds to S120. Otherwise (NO in S110), the program is ended.

In S120, ECU 8000 determines, whether or not the number of revolutions of the output shaft, namely output shaft revolution number NO, changes in a predetermined time period by a degree of change ΔNO that is larger than a threshold value ΔNO (1). When the degree of change ΔNO by which the output shaft revolution number NO changes in the predetermined time period is larger than the threshold value ΔNO (1) (YES in S120), the program proceeds to S130. Otherwise (NO in S120), the program is ended.

In S130, ECU 8000 inhibits normal gear-shifting control under which a gear to be implemented is determined based on the output shaft revolution number NO (output shaft revolution number NO on which no special process is performed). In S140, ECU, 8000 forces the gear to be shifted to any gear except for first gear (for example, to second gear).

In S150, ECU 8000 determines whether or not the degree of change ΔNO by which the output shaft revolution number NO changes in the predetermined time period is larger than a threshold value ΔNO (2) (ΔNO (2)<ΔNO (1)). When the degree of change ΔNO by which the output shaft revolution number NO changes in the predetermined time period is larger than the threshold value ΔNO (2) (YES in S150), the program returns to S150. Otherwise (NO in S150), the program proceeds to S160.

In S160, ECU 8000 cancels the inhibition of the normal gear-shifting control under which a gear to be implemented is determined based on the output shaft revolution number NO. In S170, ECU 8000 stops the forced shift to any gear except for first gear.

A description will now be given of an operation of ECU 8000 qualified as the control apparatus according to the present embodiment based on the above-described structure and flowchart.

While the vehicle is traveling, for example, the vehicle is traveling on an undulating road surface, front wheels 7000 (drive wheels) may repeat separation from and contact again with the road surface. If front wheels 7000 separate from the road surface, the drive power that is transmitted from engine 1000 via transmission 2000 to front wheels 7000 is not transmitted to the road surface and accordingly wheels 7000 turn freely.

If front wheels 7000 freely turn in a traveling state where one-way clutch F 3660 may engage, like the driven state in first gear (YES in S100, YES in S110), the inner race (ring gear R (1) (R (2)) 3450) of one-way clutch F 3660 freely rotates, resulting in a difference in number of revolutions between the outer race and the inner race. After this, when front wheels 7000 are brought into contact with the road surface, the rotation of the inner race (ring gear R (1) (R (2)) 3450) of one-way clutch F 3660 is restrained again. As this is repeated, popping of one-way clutch F 3660 could occur.

As well, if the driver is shaken and thus the accelerator pedal position repeatedly changes, it is repeated that the inner race of one-way clutch F 3660 rotates freely and the rotation of the inner race is restrained, and consequently popping of one-way clutch F 3660 could occur.

Thus, in the case where the degree of change ΔNO by which the output shaft revolution number NO changes in the predetermined time period is larger than the threshold value ΔNO (1) (YES in S120) and thus front wheels 7000 can be regarded as freely turning, the normal gear-shifting control under which a gear to be implemented is determined based on the output shaft revolution number NO is inhibited (S130). Further, the gear is forced to be shifted to any gear (for example second gear) except for first gear which is implemented by engagement of one-way clutch F 3660 (S140).

In this way, engagement of one-way clutch F 3660 can be suppressed. Here, since the normal gear-shifting control is inhibited, it can be suppressed that the gear is shifted again to first gear in which one-way clutch F 3660 engages. Thus, repeated free rotation of and restraint of rotation of the inner race of one-way clutch F 3660 can be suppressed and accordingly occurrence of popping can be suppressed. Consequently, damage to one-way clutch F 3660 due to popping can be suppressed.

Shift to any gear except for first gear leads to a lower gear ratio. Therefore, the output shaft revolution number NO, is not readily increased. Further, it does not occur that the output shaft revolution number NO increases due to such a factor as free rotation of the inner race of one-way clutch F 3660. Therefore, as the gear is shifted to any gear except for first gear, the degree of change ΔNO by which the output shaft revolution number NO, changes tends to decrease.

Therefore, even if the degree of change ΔNO by which the output shaft revolution number NO changes in the predetermined time period is equal to or smaller than the threshold value ΔNO (1), front wheels 7000 cannot be regarded as those that are not freely turning, unless the degree of change ΔNO is equal to or smaller than the threshold value ΔNO (2) which is smaller than the threshold value ΔNO (1).

In contrast, when the degree of change ΔNO by which the output shaft revolution number NO changes in the predetermined time period is equal to or smaller than the threshold value ΔNO (2) (NO in S150), front wheels 7000 can be regarded as those that are not freely turning. In this case, the inhibition of the normal gear-shifting control under which a gear to be implemented is determined based on the output shaft revolution number NO is cancelled (S160). Further, the forced shift to any gear except for first gear is stopped (S170).

In this way, at a timing precisely adjusted to the timing at which actually the popping is unlikely to occur, the inhibition of the normal gear-shifting control can be cancelled and the forced shift to any gear except for first gear can be stopped.

Thus, it can be suppressed that first gear is implemented again in the state where popping could occur and consequently popping occur. In this way, damage to one-way clutch F 3660 due to popping can be suppressed.

As seen from the above, the ECU corresponding to the control apparatus according to the present embodiment inhibits, in the case where the degree of change ΔNO by which the output shaft revolution number NO changes in a predetermined time period is larger than the threshold value ΔNO (1), the normal gear-shifting control under which a gear to be implemented is determined based on the output shaft revolution number NO. Further, the gear is forced to be shifted to any gear except for first gear which is implemented by one-way clutch F. Accordingly, engagement of one-way clutch F can be suppressed. Here, since the normal gear-shifting control is inhibited, it can be suppressed that the gear is shifted again to first gear which allows one-way clutch F 3660 to engage. Therefore, repeated free rotation and restraint of rotation of the inner race of one-way clutch F can be suppressed and thus occurrence of popping can be suppressed. Consequently, damage to one-way clutch F due to popping can be suppressed.

In the case where a difference between the number of revolutions NO (1) of the output shaft that is estimated by dividing the input shaft revolution number NIN sensed by input shaft speed sensor 8012 by the gear ratio and the number of revolutions NO (2) of the output shaft that is sensed by output shaft speed sensor 8014 (output shaft revolution number NO (2)−output shaft revolution number NO (1)) is larger than a threshold value N (0), the normal gear-shifting control under which a gear to be implemented is determined based on the output shaft revolution number NO may be inhibited and the gear may forced to be shifted to any gear except for the gear implemented by engagement of one-way clutch F 3660.

### Second Embodiment

In the following, a second embodiment of the present invention will be described. The present embodiment differs from the first embodiment in that, instead of gear shifting in the case where the degree of change ΔNO by which the output shaft revolution number NO changes in a predetermined time period is larger than the threshold value NO (1), B2 brake 3620 is engaged while the gear is maintained. Elements of the second embodiment except for the above-described one are identical to those of the first embodiment. They have the same functions as well. Therefore, the detailed description thereof is not repeated here.

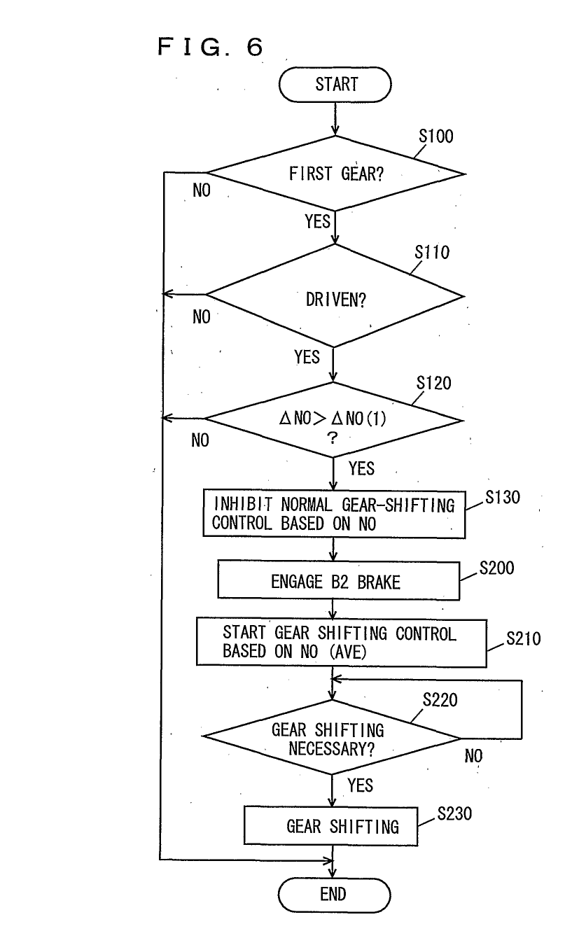

Referring to FIG. 6, a description will be given of a control structure of a program executed by ECU 8000 qualified as a control apparatus according to the present embodiment. The same process steps as those of the above-described first embodiment are denoted by the same reference number. Therefore, the detailed description thereof is not repeated here.

In S200, ECU 8000 places B2 brake 3620 in engaged state. Specifically, oil hydraulic circuit 4000 is controlled so that the oil pressure is supplied to an oil hydraulic servo of B2 brake 3620 to allow B2 brake 3620 to be in engaged state.

In S210, ECU 8000 starts gear shifting control under which a gear to be implemented is determined based on an average NO (AVE) of the output shaft revolution number NO in T (1) second(s), instead of the output shaft revolution number NO.

In S220, ECU 8000 determines whether or not gear shifting is necessary. Hit is determined that gear shifting is necessary (YES in S220), the program proceeds to S230. Otherwise (NO in S220), the program returns to S220.

In S230, ECU 8000 shifts gears by the clutch-to-clutch shift control under which B2 brake 3620 is allowed to slide while clutches or brakes to be engaged in the next gear are engaged. After this, this program is ended.

An operation will be described of ECU 8000 qualified as the control apparatus according to the present embodiment based on the above-described structure and flowchart.

In the driven state in first gear (YES in S100, YES in S110), when the degree of change ΔNO by which the output shaft revolution number NO changes in a predetermined time period is larger than the threshold value ΔNO (1) (YES in S120), the normal gear-shifting control under which a gear to be implemented is determined based on the output shaft revolution number NO is inhibited (S130). Further, the oil pressure is supplied to the oil hydraulic servo of B2 brake 3620 to place B2 brake 3620 in engaged state (S200).

Accordingly, rotation of the rotational shaft coupled to ring gear R (1) (R (2)) 3450 is suppressed, and rotation of the inner race of one-way clutch F 3660 is suppressed. Thus, a difference in number of revolutions between the outer race and the inner race of one-way clutch F 3660 is suppressed (made smaller). Consequently, repeated free rotation and restraint of rotation of the inner race of one-way clutch F 3660 can be suppressed, and thus occurrence of popping can be suppressed.

Here, since the normal gear-shifting control is inhibited, it can be suppressed that a gear is determined based on the output shaft revolution number NO that temporarily increases sharply. Thus, shift to any gear such as second gear or third gear in which B2 brake 3620 is placed in disengaged state can be suppressed. Consequently, as B2 brake 3620 is allowed to engage prior to gear shifting, occurrence of popping can be suppressed. Accordingly, damage to one-way clutch F 3660 due to popping can be suppressed.

In the state where B2 brake 3620 is engaged and first gear is kept, gear shifting control is started under which a gear to be implemented is determined based on the average NO (AVE) of the output shaft revolution number NO in T (1) second(s), instead of the output shaft revolution number NO (S210).

If gear shifting is necessary (YES in S220), the gear is shifted under the clutch-to-clutch shift control under which B2 brake 3620 is allowed to slide while clutches or brakes to be engaged in the next gear are allowed to engage (S230).

In this way, it can be suppressed that gear shifting is erroneously determined due to a temporary increase of the output shaft revolution number NO, while the vehicle can be run in an appropriate gear according to the vehicle speed in the case where the vehicle speed actually increases which entails gear shifting. Further, in gear shifting, the gear shifting shock can be suppressed by the clutch-to-clutch shift control while the gear can be shifted smoothly.

As the gear is shifted to any gear except for first gear, engagement of one-way clutch F 3660 can be suppressed. Thus, repeated free rotation and restraint of rotation of the inner race of one-way clutch F 3660 can be suppressed, and accordingly popping can be suppressed. Consequently, damage to one-way clutch F 3660 due to popping can be suppressed.

As seen from the above, the ECU corresponding to the control apparatus of the present embodiment inhibits, in the case where the degree of change ΔNO by which the output shaft revolution number NO changes in a predetermined time period is larger than the threshold value ΔNO (1), the normal gear-shifting control under which a gear to be implemented is determined based on the output shaft revolution number NO. Further, B2 brake is allowed to engage. Accordingly, a difference in number of revolutions between the outer race and the inner race of one-way clutch F can be suppressed (made smaller). Thus, occurrence of popping can be suppressed. Consequently, damage to one-way clutch F can be suppressed. Here, since the normal gear-shifting control is inhibited, it can be suppressed that a gear is determined based on the output shaft revolution number NO that temporarily increases sharply. Thus, shift to any gear in which the B2 brake is disengaged can be suppressed. Accordingly, the B2 brake is engaged prior to gear shifting, and occurrence of popping can be suppressed.

After B2 brake 3620 is engaged, instead of determining a gear to be implemented based on the average NO (AVE) of the output shaft revolution number NO, first gear may be maintained until the degree of change ΔNO by which the output shaft revolution number NO changes in the predetermined time period decreases.

In this case, until the degree of change ΔNO by which the output shaft revolution number NO changes in the predetermined time period becomes equal to or smaller than the threshold value ΔNO (2) which is smaller than the threshold value ΔNO (1), first gear may be maintained in the state where B2 brake 3620 is engaged.

When the degree of change ΔNO by which the output shaft revolution number NO changes in the predetermined time period becomes equal to or smaller than the threshold value ΔNO (2), the inhibition of the normal gear-shifting control under which a gear to be implemented is determined based on the output shaft revolution number NO may be canceled and B2 brake 3620 may be disengaged.

Further, in the case where a difference between the number of revolutions NO (1) of the output shaft that is estimated by dividing the input shaft revolution number NIN detected by input shaft speed sensor 8012 by the gear ratio and the number of revolutions NO (2) of the output shaft that is detected by output shaft speed sensor 8014 (output shaft revolution number NO (2)−output shaft revolution number NO (1)) is larger than the threshold value N (0), the normal gear-shifting control under which a gear to be implemented is determined based on the output shaft revolution number NO may be inhibited and B2 brake 3620 may be engaged.

Although the present invention has been described and illustrated in detail, it is clearly understood that the same is by way of illustration and example only and is not to be taken by way of limitation, the spirit and scope of the present invention being limited only by the terms of the appended claims.

1. A control apparatus for an automatic transmission implementing a gear by engagement of any of a plurality of frictional engagement elements (3610, 3620, 3630, 3640, 3650), at least any one of gears to be implemented being implemented by engagement of a restraining member (3660) allowing rotation of an outer race and an inner race with respect to each other in one direction and restraining rotation thereof in the opposite direction, in addition to the engagement of said frictional engagement elements (3610, 3620, 3630, 3640, 3650), said control apparatus comprising:
a sensing unit (8014) sensing the number of revolutions of an output shaft of said automatic transmission (2000);
a first control unit (8000) controlling, in the case where a degree of change by which the number of revolutions of said output shaft changes in a predetermined time period is larger than a predetermined degree of change, said frictional engagement elements (3610, 3620, 3630, 3640, 3650) so that a gear is implemented that is different from the gear implemented by the engagement of said restraining member (3660);
a second control unit (8000) controlling said frictional engagement elements (3610, 3620, 3630, 3640, 3650) so that a gear is implemented based on the number of revolutions of said output shaft; and
an inhibiting unit (8000) inhibiting the control by said second control unit (8000), in the case where said degree of change by which the number of revolutions of said output shaft changes in the predetermined time period is larger than the predetermined degree of change.

2. The control apparatus for the automatic transmission according to claim 1, said control apparatus further comprising:
a stopping unit stopping the control by said first control unit (8000), in the case where said degree of change by which the number of revolutions of said output shaft changes in the predetermined time period is at most a degree of change smaller than said predetermined degree of change under the condition that the control by said first control unit (8000) is executed while the control by said second control unit (8000) is inhibited; and
a canceling unit canceling the inhibition of the control by said second control unit (8000), in the case where said degree of change by which the number of revolutions of said output shaft changes in the predetermined time period is at most the degree of change smaller than said predetermined degree of change under the condition that the control by said first control unit (8000) is executed while the control by said second control unit (8000) is inhibited.

3. A control apparatus for an automatic transmission (2000) implementing a gear by engagement of any of a plurality of frictional engagement elements, at least any one of gears to be implemented being implemented by engagement of a restraining member (3660) allowing rotation of an outer race and an inner race with respect to each, other in one direction and restraining rotation thereof in the opposite direction, in addition to the engagement of said frictional engagement elements (3610, 3620, 3630, 3640, 3650), and a difference in number of revolutions between said outer race and said inner race being suppressed by engagement of at least any one of a plurality of said frictional engagement elements (3610, 3620, 3630, 3640, 3650), said control apparatus comprising:
a sensing unit (8014) sensing the number of revolutions of an output shaft of said automatic transmission (2000);
a first control unit (8000) controlling, in the case where a degree of change by which the number of revolutions of said output shaft changes in a predetermined time period is larger than a predetermined degree of change, said frictional engagement elements (3610, 3620, 3630, 3640, 3650) so that the difference in number of revolutions between said outer race and said inner race is suppressed;
a second control unit (8000) controlling said frictional engagement elements (3610, 3620, 3630, 3640, 3650) so that a gear is implemented based on the number of revolutions of said output shaft; and
an inhibiting unit (8000) inhibiting the control by said second control unit (8000), in the case where said degree of change by which the number of revolutions of said output shaft changes in the predetermined time period is larger than the predetermined degree of change.

4. The control apparatus for the automatic transmission according to claim 3, said control apparatus further comprising a third control unit controlling, in the case where the control by said second control unit (8000) is inhibited, said frictional engagement elements (3610, 3620, 3630, 3640, 3650) so that a gear is implemented based on an average of the number of revolutions of said output shaft in a predetermined time period.

5. The control apparatus for the automatic transmission according to claim 3, said control apparatus further comprising:
a stopping unit stopping the control by said first control unit (8000), in the case where said degree of change by which the number of revolutions of said output shaft changes in the predetermined time period is at most a degree of change smaller than said predetermined degree of change under the condition that the control by said first control unit (8000) is executed while the control by said second control unit (8000) is inhibited; and
a canceling unit canceling the inhibition of the control by said second control unit (8000), in the case where said degree of change by which the number of revolutions of said output shaft changes in the predetermined time period is at most the degree of change smaller than said predetermined degree of change under the condition that the control by said first control unit (8000) is executed while the control by said second control unit (8000) is inhibited.

6. A control apparatus for an automatic transmission implementing a gear by engagement of any of a plurality of frictional engagement elements (3610, 3620, 3630, 3640, 3650), at least any one of gears to be implemented being implemented by engagement of a restraining member (3660) allowing rotation of an outer race and an inner race with respect to each other in one direction and restraining rotation thereof in the opposite direction, in addition to the engagement of said frictional engagement elements (3610, 3620, 3630, 3640, 3650), said control apparatus comprising:
sensing means (8014) for sensing the number of revolutions of an output shaft of said automatic transmission (2000);
first control means (8000) for controlling, in the case where a degree of change by which the number of revolutions of said output shaft changes in a predetermined time period is larger than a predetermined degree of change, said frictional engagement elements (3610, 3620, 3630, 3640, 3650) so that a gear is implemented that is different from the gear implemented by the engagement of said restraining member (3660);
second control means (8000) for controlling said frictional engagement elements (3610, 3620, 3630, 3640, 3650) so that a gear is implemented based on the number of revolutions of said output shaft; and
inhibiting means (8000) for inhibiting the control by said second control means (8000), in the case where said degree of change by which the number of revolutions of said output shaft changes in the predetermined time period is larger than the predetermined degree of change.

7. The control apparatus for the automatic transmission according to claim 6, said control apparatus further comprising:
means for stopping the control by said first control means (8000), in the case where said degree of change by which the number of revolutions of said output shaft changes in the predetermined time period is at most a degree of change smaller than said predetermined degree of change under the condition that the control by said first control means (8000) is executed while the control by said second control means (8000) is inhibited; and
means for canceling the inhibition of the control by said second control means (8000), in the case where said degree of change by which the number of revolutions of said output shaft changes in the predetermined time period is at most the degree of change smaller than said predetermined degree of change under the condition that the control by said first control means (8000) is executed while the control by said second control means (8000) is inhibited.

8. A control apparatus for an automatic transmission (2000) implementing a gear by engagement of any of a plurality of frictional engagement elements, at least any one of gears to be implemented being implemented by engagement of a restraining member (3660) allowing rotation of an outer race and an inner race with respect to each other in one direction and restraining rotation thereof in the opposite direction, in addition to the engagement of said frictional engagement elements (3610, 3620, 3630, 3640, 3650), and a difference in number of revolutions between said outer race and said inner race being suppressed by engagement of at least any one of a plurality of said frictional engagement elements (3610, 3620, 3630, 3640, 3650), said control apparatus comprising:
sensing means (8014) for sensing the number of revolutions of an output shaft of said automatic transmission (2000);
first control means (8000) for controlling, in the case where a degree of change by which the number of revolutions of said output shaft changes in a predetermined time period is larger than a predetermined degree of change, said frictional engagement elements (3610, 3620, 3630, 3640, 3650) so that the difference in number of revolutions between said outer race and said inner race is suppressed;
second control means (8000) for controlling said frictional engagement elements (3610, 3620, 3630, 3640, 3650) so that a gear is implemented based on the number of revolutions of said output shaft; and
inhibiting means (8000) for inhibiting the control by said second control means (8000), in the case where said degree of change by which the number of revolutions of said output shaft changes in the predetermined time period is larger than the predetermined degree of change.

9. The control apparatus for the automatic transmission according to claim 8, said control apparatus further comprising means for controlling, in the case where the control by said second control means (8000) is inhibited, said frictional engagement elements (3610, 3620, 3630, 3640, 3650) so that a gear is implemented based on an average of the number of revolutions of said output shaft in a predetermined time period.

10. The control apparatus for the automatic transmission according to claim 8, said control apparatus further comprising:
means for stopping the control by said first control means (8000), in the case where said degree of change by which the number of revolutions of said output shaft changes in the predetermined time period is at most a degree of change smaller than said predetermined degree of change under the condition that the control by said first control means (8000) is executed while the control by said second control means (8000) is inhibited; and
means for canceling the inhibition of the control by said second control means (8000), in the case where said degree of change by which the number of revolutions of said output shaft changes in the predetermined time period is at most the degree of change smaller than said predetermined degree of change under the condition that the control by said first control means (8000) is executed while the control by said second control means (8000) is inhibited.

11. A control apparatus for an automatic transmission implementing a gear by engagement of any of a plurality of frictional engagement elements (3610, 3620, 3630, 3640, 3650), at least any one of gears to be implemented being implemented by engagement of a one-way clutch (3660) allowing rotation of an outer race and an inner race with respect to each other in one direction and restraining rotation thereof in the opposite direction, in addition to the engagement of said frictional engagement elements (3610, 3620, 3630, 3640, 3650), said control apparatus comprising:
an output shaft revolution number sensor (8014) sensing the number of revolutions of an output shaft of said automatic transmission (2000); and
an ECU (8000),
said ECU (8000) controlling, in the case where a degree of change by which the number of revolutions of said output shaft changes in a predetermined time period is larger than a predetermined degree of change, said frictional engagement elements (3610, 3620, 3630, 3640, 3650) so that a gear is implemented that is different from the gear implemented by the engagement of said one-way clutch (3660),
said ECU (8000) controlling said frictional engagement elements (3610, 3620, 3630, 3640, 3650) so that a gear is implemented based on the number of revolutions of said output shaft, and
said ECU (8000) inhibiting the control by said ECU (8000) of said frictional engagement elements so that a gear is implemented based on the number of revolutions of said output shaft, in the case where said degree of change by which the number of revolutions of said output shaft changes in the predetermined time period is larger than the predetermined degree of change.

12. A control apparatus for an automatic transmission (2000) implementing a gear by engagement of any of a plurality of frictional engagement elements, at least any one of gears to be implemented being implemented by engagement of a one way clutch (3660) allowing rotation of an outer race and an inner race with respect to each other in one direction and restraining rotation thereof in the opposite direction, in addition to the engagement of said frictional engagement elements (3610, 3620, 3630, 3640, 3650), and a difference in number of revolutions between said outer race and said inner race being suppressed by engagement of at least any one of a plurality of said frictional engagement elements (3610, 3620, 3630, 3640, 3650), said control apparatus comprising:
an output shaft revolution number sensor (8014) sensing the number of revolutions of an output shaft of said automatic transmission (2000); and
an ECU (8000),
said ECU (8000) controlling, in the case where a degree of change by which the number of revolutions of said output shaft changes in a predetermined time period is larger than a predetermined degree of change, said frictional engagement elements (3610, 3620, 3630, 3640, 3650) so that the difference in number of revolutions between said outer race and said inner race is suppressed,
said ECU (8000) controlling said frictional engagement elements (3610, 3620, 3630, 3640, 3650) so that a gear is implemented based on the number of revolutions of said output shaft, and
said ECU (8000) inhibiting the control by said ECU (8000) of said frictional engagement elements so that a gear is implemented based on the number of revolutions of said output shaft, in the case where said degree of change by which the number of revolutions of said output shaft changes in the predetermined time period is larger than the predetermined degree of change.

13. A control method for an automatic transmission implementing a gear by engagement of any of a plurality of frictional engagement elements, at least any one of gears to be implemented being implemented by engagement of a restraining member allowing rotation of an outer race and an inner race with respect to each other in one direction and restraining rotation thereof in the opposite direction, in addition to the engagement of said frictional engagement elements, said control method comprising the steps of:
determining whether or not a degree of change by which the number of revolutions of an output shaft of said automatic transmission changes in a predetermined time period is larger than a predetermined degree of change; and
inhibiting gear-shifting control under which a gear to be implemented is determined based on the number of revolutions of said output shaft and controlling said frictional engagement elements so that a gear is implemented that is different from the gear implemented by the engagement of said restraining member, in the case where it is determined that said degree of change by which the number of revolutions of said output shaft changes in the predetermined time period is larger than said predetermined degree of change.

14. The control method for the automatic transmission according to claim 13, further comprising the steps of:
determining, when the gear-shifting control under which a gear to be implemented is determined based on the number of revolutions of said output shaft is inhibited and said frictional engagement elements are controlled so that a gear is implemented that is different from the gear implemented by the engagement of said restraining member, whether or not said degree of change by which the number of revolutions of said output shaft changes in the predetermined time period is at most a degree of change smaller than said predetermined degree of change; and
canceling the inhibition of the gear-shifting control under which a gear to be implemented is determined based on the number of revolutions of said output shaft, in the case where it is determined that said degree of change by which the number of revolutions of said output shaft changes in the predetermined time period is at most a degree of change smaller than said predetermined degree of change, when the gear-shifting control under which a gear to be implemented is determined based on the number of revolutions of said output shaft is inhibited and said frictional engagement elements are controlled so that a gear is implemented that is different from the gear implemented by the engagement of said restraining member.

15. A control method for an automatic transmission implementing a gear by engagement of any of a plurality of frictional engagement elements, at least any one of gears to be implemented being implemented by engagement of a restraining member allowing rotation of an outer race and an inner race with respect to each other in one direction and restraining rotation thereof in the opposite direction, in addition to the engagement of said frictional engagement elements, and a difference in number of revolutions between said outer race and said inner race being suppressed by engagement of at least any one of a plurality of said frictional engagement elements, said control method comprising the steps of:
determining whether or not a degree of change by which the number of revolutions of an output shaft of said automatic transmission changes in a predetermined time period is larger than a predetermined degree of change; and
inhibiting gear-shifting control under which a gear to be implemented is determined based on the number of revolutions of said output shaft and controlling said frictional engagement elements so that the difference in number of revolutions between said outer race and said inner race is suppressed, in the case where it is determined that said degree of change by which the number of revolutions of said output shaft changes in the predetermined time period is larger than said predetermined degree of change.

16. The control method for the automatic transmission according to claim 15, further comprising the step of executing gear-shifting control under which a gear to be implemented is determined based on an average of the number of revolutions of said output shaft in a predetermined time period, in the case where the gear-shifting control under which a gear to be implemented is determined based on the number of revolutions of said output shaft is inhibited.

17. The control method for the automatic transmission according to claim 15, further comprising the steps of:
determining, when the gear-shifting control under which a gear to be implemented is determined based on the number of revolutions of said output shaft is inhibited and said frictional engagement elements are controlled so that the difference in number of revolutions between said outer race and said inner race is suppressed, whether or not said degree of change by which the number of revolutions of said output shaft changes in the predetermined time period is at most a degree of change smaller than said predetermined degree of change; and
stopping the control of said frictional engagement elements for suppressing the difference in number of revolutions between said outer race and said inner race and canceling the inhibition of the gear-shifting control under which a gear to be implemented is determined based on the number of revolutions of said output shaft, in the case where it is determined that said degree of change by which the number of revolutions of said output shaft changes in the predetermined time period is at most a degree of change smaller than said predetermined degree of change, when the gear-shifting control under which a gear to be implemented is determined based on the number of revolutions of said output shaft is inhibited and said frictional engagement elements are controlled so that the difference in number of revolutions between said outer race and said inner race is suppressed.
